(19) United States
(12) Patent Application Publication
(10) Pub. No.: US 2008/0080943 A1
(43) Pub. Date: Apr. 3, 2008

(54) MOTOR SPINDLE AS A ROTARY DRIVE FOR TOOLS ON A MACHINE TOOL

(75) Inventors: Franz-Xaver BERNHARD, Spaichingen (DE); Tobias Schwcrer, Konigsheim (DE)

Correspondence Address: BROWDY AND NEIMARK, P.L.L.C.;624 NINTH STREET, NW, SUITE 300, WASHINGTON, DC, 20001-5303, US

(73) Assignee: Maschinen Fabrik, Berthold Hermle AG, Gosheim (DE)

(21) Appl. No.: 11/858,704

(22) Filed: Sep. 20, 2007

(30) Foreign Application Priority Data
Sep. 20, 2006 (EP) 06 019 630.0

(51) Int. Cl. B23C 1/00

(52) U.S. Cl. 409/233

(57) ABSTRACT

A motor spindle for causing rotation of tools on a machine tool has a spindle motor with a motor shaft and a spindle shaft driven by the motor shaft and having a tool clamping means. From the tool clamping means there extends through the spindle shaft and the motor shaft an axially sliding draw rod for clamping tools or tool receiving means. The motor shaft is supported in a rotatable fashion, independently of the spindle shaft in a motor housing and the spindle shaft is supported independently from the motor shaft in a spindle housing, which is attached to the motor housing in a detachable manner. The spindle shaft is coupled in an interlocking manner in the direction of rotation with the motor shaft but is able to freely slide in it. The spindle housing constitutes a single structural unit with the tool clamping means and its draw rod, such draw rod being accommodated in the motor shaft for free sliding motion with the result that the entire structural unit can be removed without the spindle motor or its bearing means being impaired in any way or having to be detached.

### BACKGROUND OF THE INVENTION

The invention relates to a motor spindle as a rotary drive for tools on a machine tool, comprising a spindle motor, said spindle motor having a motor shaft, and a spindle shaft driven by said motor shaft and possessing a tool holder means, and a draw rod which extends from the tool holder means through the spindle shaft and the motor shaft in a sliding manner, of the tool holder means for tools or tool receiving means.

### THE PRIOR ART

In the case of such a modular motor spindle disclosed in the German patent publication DE 2020050180002 U1 with inner coolant supply the motor shaft is identical with the spindle shaft, i. e. the motor shaft also bears the tool holder means for receiving the respective tool. This motor spindle may admittedly be disassembled on site but however it is then necessary to dismantle the drive motor with the entire motor bearings. This procedure with such a complete disassembly of the motor on site has however turned out to be extremely disadvantageous in practice. A complete detachment of the motor with the motor bearings must as a rule be performed adhering strictly to an extremely strict dismantling protocol in order to prevent soiling the high precision motor bearings. The quality of the dynamic balance of the motor is generally impaired on re-assembly with the result that the entire system must be dynamically rebalanced. Such conditions for assembly cannot be generally achieved on site so chat in practice the disassembly of such a spindle motor can only be properly performed on the manufacturer's premises.

A further motor spindle of the type initially mentioned is described in the German patent publication DE 10240737 A1. This motor spindle also possesses an internal coolant supply but however has a two-part drive shaft. The two shaft parts, i. e. the motor shaft and the spindle shaft, are however not provided with separate bearings and the motor shaft is fixed at one end by means of screws on the spindle shaft and supported by same as a bearing. The two shaft sections must consequently be connected together in the assembled state in an interlocking and force transmitting manner and must be held in their relative axial position in order to achieve an exact bearing setting. On detachment of the spindle shaft from the motor shaft the motor shaft is no longer borne by a bearing at one end and on refitting must be readjusted and dynamically rebalanced having regard to the high speeds of rotation. This will mean that detachment and refitting is practically not possible on site. Furthermore this patent publication fails to provide an indication that the tool holder means, and more particularly its draw rod, constitutes a component of the spindle shaft section and may be detached together with it.

### SHORT SUMMARY OF THE INVENTION

One object of the invention is to so redesign a motor spindle of the type initially mentioned that simple dismantling of the initially mentioned tool holder means together with the spindle shaft may be so implemented that the bearing of the motor shaft remains unimpaired and the spindle motor does not have to be detached at all.

In order to achieve these and/or other objects appearing from the present specification, claims and drawings, in the present invention provides a motor spindle with the features recited in claim 1.

The advantages of the motor spindle in accordance with the invention are more especially that owing to the modular construction, that is to say the separate bearing means for the motor shaft in the motor housing and the spindle shaft, in the spindle housing and also the axially freely sliding of the spindle shaft coupled with the motor shaft a rapid and simpler detachment of the spindle housing from the motor housing may take place, it merely being necessary to undo housing screws. The spindle motor itself is then not impaired in any way. Furthermore owing to the axial sliding coupling between the motor shaft and the spindle shaft it is possible for the drive motor with its bearings to be relatively simply protected against axial impacts due to collisions. If it comes a collision the spindle shaft may be axially shifted without forces being transmitted to the bearings of the motor. A further substantial advantage is that on separating the spindle housing from the motor housing the tool holder means or, respectively, their draw rod may be pulled out as well without any dismantling operations being necessary for this purpose. The most wear-prone parts of a motor spindle are normally the tool holder means, whose disk spring stack must normally be replaced after a certain number of clamping strokes, and the bearing of the spindle shaft, which during a machining using one tool are subject to most load. Owing to the simple and rapid detachment of the spindle housing such detachment may take place on site and on the other hand all particularly wear-prone parts may be detached as a single assembly. On site a new assembly may be employed without any major adjustment operations or dynamic balancing operations being necessary.

Further advantageous developments and improvements of the invention are defined in the claims directed to the motor spindle of claim 1.

The coupling, which is interlocking in the direction of rotation, between the spindle shaft and the motor shaft and which permits a mutual axial displacement, is preferably designed in the form of gear splines and more particularly in the form of a ring of splines. Preferably in this respect the motor shaft has a spline ring portion with internal splines with which aa splined hub of the spindle shaft interlocks. This renders possible a particularly simple and rapid uncoupling and coupling by sliding inward or outward.

One bearing means for the motor shaft in the motor housing is then preferably designed as a bearing for the splined ring portion.

Furthermore the motor shaft preferably has a pillow block provided for the motor shaft on the side facing away from the spindle housing.

For control or, respectively, regulation of the speed of rotation of the motor spindle or, respectively, of the machining tool the motor shaft cooperates with a speed of rotation sensor, which in particular is arranged in a pillow block of the motor housing. For independent bearing of the motor shaft and the spindle shaft in their respective housings the motor shaft in the motor housing and the spindle shaft in the spindle housing preferably possess at least two bearing points.

The spindle housing is preferably screwed to the motor housing with the result that for removal of the spindle housing forming a single structural unit with the tool holder means merely the housing screws must be unscrewed.

The draw rod of the tool holder means has a collet at its end adjacent to the tool receiving means, such collet cooperating with a tool clamping claw and at the opposite end has a gauge section which cooperates with a position detecting sensor system to detect the axial position of the draw rod, and in particular with at least one contact-free position sensor in order to not involve any additional assembly operations on drawing out the draw rod when removing the spindle housing.

Preferably an actuating unit is provided for the actuation of the draw rod at the end portion, facing away from the spindle housing, of the motor housing. This actuation unit may also be removed or, respectively, replaced in a simple fashion by unscrewing the holding screws. The actuation unit preferably comprises a fluid operated servo member for axial displacement of the draw rod.

The draw rod is provided spring means exerting a clamping force for holding a respective tool and which may be in particular arranged on the draw rod within the motor shaft and the actuation unit is designed for shifting the draw rod against the spring of the spring means for releasing the tool. Accordingly the tool or, respectively, the tool receiving means is held by spring force when the actuation unit is not operated and may be released by actuation of the actuation unit.

Further advantageous developments and convenient forms of the invention will be understood from the following detailed descriptive disclosure of one embodiment thereof in conjunction with the accompanying drawings.

### LIST OF THE SEVERAL VIEWS OF THE FIGURES

FIG. 1 shows a motor spindle as working example of the invention in longitudinal section.

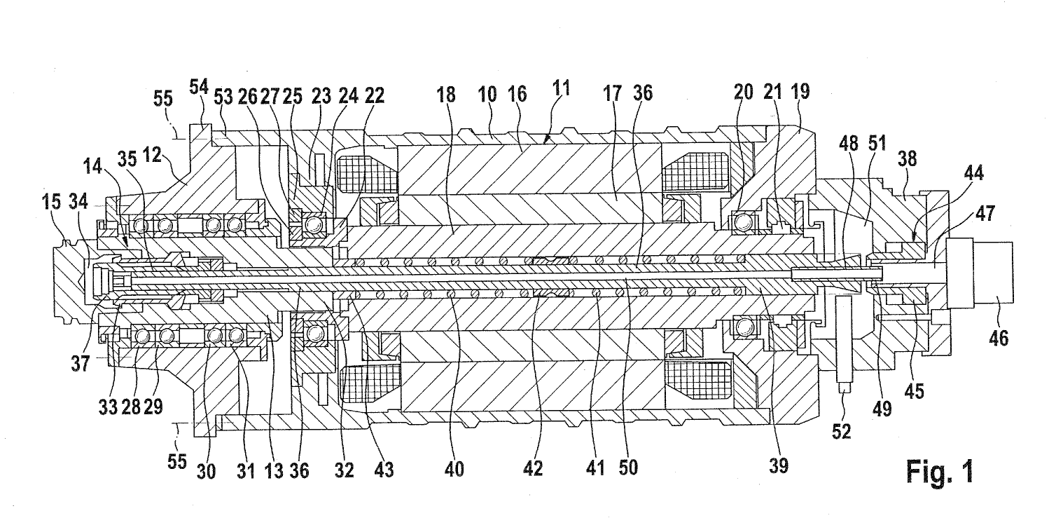

FIG. 2 illustrates the tool holder means and the spindle housing comprising an assembly unit in a separate manner of representation.

### DETAILED ACCOUNT OF WORKING EMBODIMENT OF THE INVENTION

The motor spindle depicted in the figures is designed in a compact fashion and serves to drive cutting tools in rotation on a machine tool. The motor spindle includes two housings which are screwed together, namely a motor housing 10 for a spindle motor 11 and a spindle housing 12, for a spindle shaft 13 and a tool holder means 14 for clamping a machining cool or a tool receiving means 15 holding such a cutting cool.

The spindle motor 11 in the motor housing 10 exhibits an external stator 16 and an internal rotor 17, which

fits around a motor shaft 18 in the form of a hollow shaft. The motor housing 11 is terminated at an end portion, remote from the spindle housing 12, by a pillow block 19, which contains an anti-friction bearing 20 as a rotary bearing for the motor shaft 18 on this one side. Moreover, in this pillow block 19 there is a rotation sensor 21 responsive to the speed of rotation of the motor shaft 18 and thus of the spindle motor 11.

The motor shaft 18 is on the spindle housing side fixedly connected with a tubular splined ring element 22 having an internal ring of splines. The spline ring element 22 and with it the corresponding end of the motor shaft 18 is rotatably supported on an annular housing portion 23 by means of a further anti-friction bearing 24. The anti-friction bearing 24 lies in this case at the periphery on a ring-like bearing socket 25, which constitutes an intermediate member between the anti-friction bearing 24 and the ring-like housing portion 23. The anti-friction bearing 24 is secured by means of two threaded elements 26 and 27 on the splined ring element 22 and, respectively, in the bearing socket 25.

The spindle shaft 13 is supported in a rotatable manner in the spindle housing 12 using four anti-friction bearings 28 through 31. The number of the anti-friction bearings 28 through 31 and also of the anti-friction bearings 20 and 24 for supporting the motor shaft 18 may naturally be varied although however at least two bearing points are necessary in order to provide independent bearing means for the two shafts, namely the spindle shaft 13 and the motor shaft 18.

A cylindrical end portion, which faces the motor housing 10, of the spindle shaft 13 is provided as a splined hub 32 with peripheral splines for meshing with the splined ring element 22 on the motor shaft 18 and accordingly providing a torque transmitting spline enclosure means between the spindle shaft 13 arid the motor shaft 18. In this case the splined hub 32 and thus the spindle shaft 13 are able to slide owing to these splines axially in relation to the motor shaft 18.

The tool holder means 14 in the spindle shaft 13 essentially comprises a tubular tool clamping claw 33 which in a known manner fits into a recess 34 in the respective tool receiving means 15. The tool clamping claw 33 in this case fits around a collet 35, which by means of a draw rod 26 connected firmly to same, is able to be slid in relation to the tool clamping claw 33. The collet 35 has at one end a bracing head 37 which during an axial movement of the draw rod 36 toward the motor housing 10 urges the elastic tool clamping claw 33 within the recess 34 radially outward and accordingly locks the tool receiving means 15 to the spindle shaft 13.

The draw rod 36 extends from the spindle shaft 13 through the motor shaft 18 and terminates in an actuating unit 38, which is secured to the pillow block 19. The draw rod 36, which slides axially in the spindle shaft 13, possesses an annular ledge 39 at its terminal portion remote from the spindle housing 12, the diameter of such ledge being slightly smaller than the internal diameter of a concentric longitudinal channel through the motor shaft 18 with the result that the annular ledge 39 and accordingly also the draw rod 36 are able to slide in the longitudinal channel and thus in the motor shaft 18 freely. Two disk spring stacks 40 and 41 fit round the draw rod 36 like washers and are separated from each other by a support disk 42 in the middle portion of the motor shaft 18. These two disk spring stacks 40 and 41 bear on the one hand against the annular ledge 39 and on the other hand by way of a disk shim 43 against the spindle shaft 12 so that the collet 35, owing to the force of the two disk spring stacks 40 and 41, shifts the tool clamping claws apart and accordingly secures the tool receiving means 15 in the spindle shaft 13. A fluid power servo member 44 in the form of a power cylinder in the actuating unit 38 possesses a piston 45 able to be shifted axially by fluid power, which on actuation of the actuating unit 38 is moved aginsst the draw rod 36 and thrusts it toward the spring force of the disk spring stack 40 and 41 toward the spindle housing 12. Accordingly the collet 35 is thrust out of the tool clamping claw 33 so that the tool receiving means 15 is released and can be removed. Coolant and/or lubricant may be transferred by way of a rotary union 46 into a duct 47 aligned with the draw rod 36 in the interior of the actuating unit 38. Into this duct there extends a small tube 48 secured at one end to the draw rod 36, the tube 48 being sealed by sealing elements 49 to ensure a sealing connection with the duct 47. The draw rod 36 is tubular in configuration with the result that coolant and/or lubricant may flow from the tube 48 through a concentric longitudinal duct 50 in the draw rod 36 to the tool clamping means 14 in the spindle shaft 13 and thus to the tool receiving socket 15 and to the respective machining tool held therein.

The end portion, extending from the motor shaft 18 into a cavity 51 in the actuating unit, is ball-like in form and cooperates with a contact-free displacement sensor 52 in order to detect the position of the draw rod 36 and thus the strain condition of the tool clamping means 14. Other known position detection instrumentalities could naturally be also employed here as well.

On the spindle housing side the motor housing 10 possesses a tube-like end portion 53 into which the spindle housing 12 partially fits. An annular flange 54 on the spindle housing 12 abuts the end face of this end portion 53, attachment screws 55 serving for securing such annular flange 54 and thus the spindle housing 12 on this end portion 53 and thus on the motor housing 10.

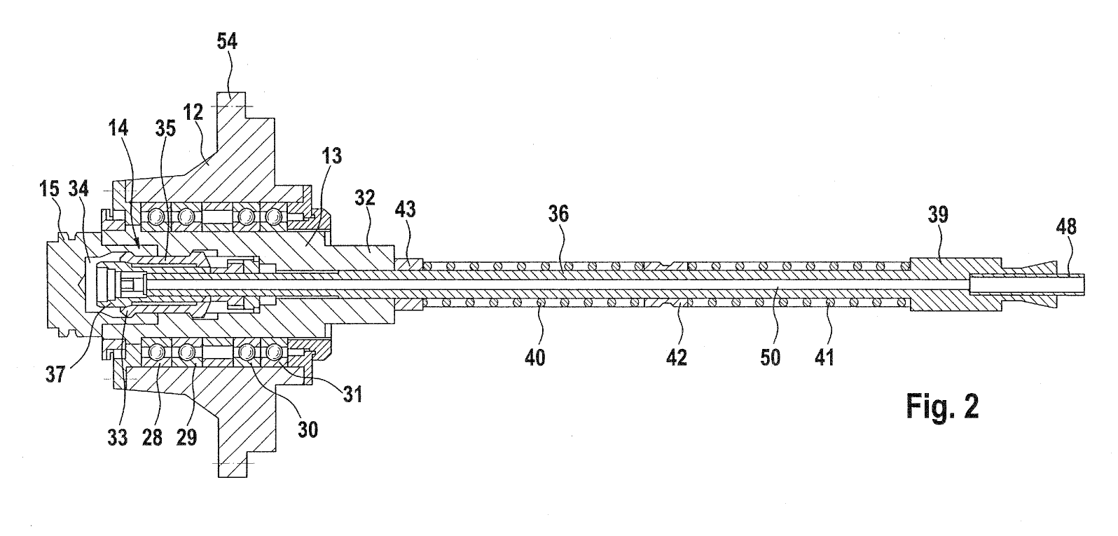

For removal of the spindle housing 12 the attachment screws 55 are slackened off and then the spindle housing 12 may be pulled off. Then the splined hub 32 slides clear of the splined ring element 22 and the draw rod 36 with the disk spring stacks 40 and 4 will slide out of the motor shaft 18. This structural unit, made up of the spindle housing 12 and the draw rod 16, able to be removed bodily is illustrated in FIG. 2 separately. Owing to the independent bearing means for the motor shaft 18 and thus of the spindle motor 11 the latter does not therefore need to be disassembled or altered in any way for the removal of this structural unit and a repaired or new structural unit in accordance with FIG. 2 only needs to be inserted and secured by means of the attachment screws 55. Accordingly no major adjustment or dynamic balancing operations are needed.

1. A motor spindle as a rotary drive for tools on a machine tool, comprising a spindle motor, said spindle motor having a motor shaft, and a spindle shaft driven by said motor shaft and possessing a tool holder means, and a draw rod which extends from the tool holder means through the spindle shaft and the motor shaft in a sliding manner, of the tool holder means for tools or tool receiving means, wherein the motor shaft is rotatably supported independently from the spindle shaft in a motor housing and the spindle shaft is rotatably supported independently from the motor shaft in a spindle housing, the spindle housing is detachably secured on the motor housing and the spindle shaft is coupled interlockingly in the direction of rotation with the motor shaft while being free to axially slide, and the spindle housing constitutes a self-contained structural unit with its tool clamping means, such draw rod being arranged in the motor shaft for free sliding motion.

2. The motor spindle as set forth in claim 1, wherein the coupling, which interlocks in the direction of rotation, between the spindle shaft and the motor shaft is in the form of splines and more particularly in the form of a ring of splines.

3. The motor spindle as set forth in claim 2, wherein the motor shaft, in a part thereof facing the spindle shaft, has a spline ring with internal splines for engagement with a splined hub of the spindle shaft.

4. The motor spindle as set forth in claim 3, wherein a bearing means on the motor shaft is designed for bearing the spline ring portion.

5. The motor spindle as set forth in claim 1, wherein the motor housing at its side facing away from the spindle housing has a pillow block provided with a bearing point for the motor shaft.

6. The motor spindle as set forth in claim 1, wherein the motor shaft is adapted to cooperate with a speed of rotation sensor which is more particularly arranged on a pillow block in the motor housing.

7. The motor spindle as set forth in claim 1, wherein the motor shaft in the motor housing and the spindle shaft in the spindle housing each have at least two bearing points for bearing same.

8. The motor spindle as set forth in claim 1, wherein the spindle housing is screwed to the motor housing.

9. The motor spindle as set forth in claim 1, wherein at the tool receiving means side thereof the draw rod possesses a collet adapted to cooperate with a tool clamping claw and at the opposite end possesses a gauge section for cooperation with a position sensor system and in particular with at least one position sensor operating without making physical contact.

10. The motor spindle as set forth in claim 1, wherein an actuating unit is arranged for actuation of the draw rod at the end portion remote from the spindle housing of the motor housing and is in particular arranged on the pillow block thereof.

11. The motor spindle as set forth in claim 10, wherein the actuating unit comprises a fluid-operated servo member for axial displacement of the draw rod.

12. The motor spindle as set forth in claim 10, wherein the draw rod is provided with spring means adapted to exert a clamping force for holding the respective tool or the respective tool receiving means, such spring means being in particular arranged within motor shaft on the draw rod and the actuating unit is designed to slide the draw rod against the spring force of the spring means for releasing the tool or the tool receiving means.
